(19) United States
(12) Patent Application Publication
(10) Pub. No.: US 2026/0235108 A1
(43) Pub. Date: Aug. 13, 2026

(54) SEMI-SUBMERSIBLE FLOAT FOR AN OFFSHORE WIND TURBINE AND METHOD FOR CONSTRUCTING SUCH A FLOAT

(71) Applicant: SAIPEM S.A., Puteaux (FR)

(72) Inventors: Sébastien VIMEUX, Puteaux (FR); Nicolas FIERS, Puteaux (FR); Pierre WEYNE, Puteaux (FR); Eric KERDILES, Puteaux (FR)

(21) Appl. No.: 19/156,046

(22) PCT Filed: Feb. 8, 2024
(86) PCT No.: PCT/FR2024/050174

§ 371 Date: Aug. 13, 2025

(30) Foreign Application Priority Data
Feb. 13, 2023 (FR) 23 01328

(51) Int. Cl. F03D 13/25; B63B 35/44; B63B 75/00; F03D 13/20

(52) U.S. Cl. CPC F03D 13/256; B63B 35/44; B63B 75/00; F03D 13/202; B63B 2035/446; F05B 2240/932; F05B 2240/95

(57) ABSTRACT

A semi-submersible float has four columns including a central column intended to receive a wind turbine mast, and at least three external columns that are connected to the central column by branches forming lower pontoons. The float is devoid of upper branches connecting the central column to the external columns and the external columns and the lower pontoons are each formed by an assembly of planar panels and each have a polyhedral cross-section. A method is provided for constructing such a float.

### TECHNICAL FIELD

The present invention relates to the general field of semi-submersible floats used for offshore wind turbines.

More specifically, it concerns a new semi-submersible float architecture and a method for constructing such a float.

### PRIOR ART

An offshore wind turbine aims to use wind energy in order to produce electricity using a turbine and an electric generator. There are two main types of offshore wind turbines: fixed wind turbines which are implanted on the seabed (at shallow depths, typically less than 50 m), and floating wind turbines which offer the advantage of being able to be built onshore and implanted in areas where the seabed depth typically exceeds 50 m.

The floating wind turbines covered by the present invention comprise a turbine generally formed by a motor with several horizontal axis rotating airfoils and an electric generator coupled to the motor, the motor and the generator being fixed to an upper end of a vertical mast (or pylon). The lower end of the mast is mounted on a floating support structure (hereinafter referred to as float).

There are several main families of floats for offshore wind turbines: semi-submersible floats, immersed floats with tensioned cables (or TLP platforms for Tension-Leg Platform), SPAR (for Single Point Anchor Reservoir) floats, semi-submersible floats of the “barge” type, and floats with a pendulum counterweight.

The invention more specifically relates to semi-submersible floats, that is to say steel or concrete foundations which generally take the form of a tripod with three (or four) cylindrical columns connected to each other by metal structures. The stability of the structure is ensured by a ballasting system which allows the immersion of part of the foundation. This structure is characterized by its large size and reduced draft.

For example, reference can be made to publication FR 3,064,973 which describes a semi-submersible hybrid float structure including a central column and three external columns connected to the central column by pontoon-shaped branches.

Although of relatively simple design, this hybrid float has the drawback of having a relatively long assembly time and potentially high manufacturing costs.

### DISCLOSURE OF THE INVENTION

The object of the invention is therefore to propose a semi-submersible float structure that offers extremely short construction and delivery time for low costs.

This aim is achieved by means of a semi-submersible float, in particular for an offshore wind turbine, comprising four columns including a central column intended to receive a wind turbine mast, and at least three external columns that are connected to the central column by branches forming lower pontoons, and in which, in accordance with the invention, it is devoid of upper branches connecting the central column to the external columns and the external columns and the lower pontoons are each formed by an assembly of planar panels and each have a polyhedral cross-section.

The float according to the invention is remarkable in that the main elements that compose it (external columns and lower pontoons) result from an assembly of a plurality of planar panels, which greatly facilitates the manufacture of the float. Due to this particularity, the construction and delivery times of the float can be significantly reduced due to a more abundant supply chain than that of the prior art large-diameter cylindrical columns (because it opens up to global capabilities in the shipbuilding field).

This makes it possible to propose a robust and qualified float that meets the operating conditions of the implantion site and the required performance with an attractive cost/performance ratio. The associated risks are also contained due to the simplicity of construction.

Preferably, the central column is formed by an assembly of planar panels and has a polyhedral cross-section. This arrangement allows further reducing the construction times and costs of the float.

The central column may advantageously end with a transition piece having a downwardly-tapered truncated cone shape.

Alternatively, the central column may advantageously have a downwardly-tapered truncated cone shape. The presence of a downwardly-tapered truncated cone is particularly advantageous for the overall design of the wind turbine.

The external columns may have the same height and the central column may have a height different from that of the external columns.

Preferably, the central column comprises an access door to a tower supporting the turbine of the wind turbine located below the interface with the tower and internal extra reinforcements of the interface with the tower. This access door allows the operators to enter the structure to access the equipment positioned inside the tower. Compared to the prior art, in which the access door is generally positioned a few meters above the interface with the tower, the position of the access door is here advantageously lowered by several meters to be removed from the area of the internal reinforcements of the interface with the tower.

Also preferably, the planar panels forming the external columns are assembled together by at least one rounded rod so as to improve their hydrodynamic behavior and reduce stress concentrations.

The planar panels forming the external columns and the lower pontoons may advantageously be reinforced by longitudinal inner stiffeners and/or transverse inner stiffeners.

The planar panels forming the external columns and the lower pontoons may also be reinforced by longitudinal outer stiffeners and/or transverse outer stiffeners. Compared to inner stiffeners, outer stiffeners have the advantage of facilitating the welding operations necessary for the installation of such stiffeners.

Still more preferably, the external columns are connected to each other by prestressed cables. These prestressed cables have the advantage of absorbing some of the out-of-plane forces and thus reducing the load on the structure, and therefore its mass.

The float may further comprise members, each extending between the central column and one of the lower pontoons, in order to partly transfer the in-plane loads from the central column to the lower pontoons. Such members may have a tubular or polyhedral shape.

The lower pontoons may be angularly spaced from each other by 120° to form a star-shaped structure.

The invention also relates to a method for the modular construction of a float as defined above, comprising:
the assembly of planar panels together to form, on the one hand, the lower pontoons and, on the other hand, the external columns
the assembly of the lower pontoons to a central branched structure supporting the central column
the assembly of the external columns on the lower branches, and
the assembly of the central column on the central branched structure.

The lower pontoons can be assembled onto the central branched structure by welding. In this case, the welds for assembling the lower pontoons onto the central branched structure are advantageously external, using outer stiffeners connected by welding so as to facilitate their installation.

Alternatively, the lower pontoons can be assembled onto the central branched structure by means of mechanical connectors.

Moreover, the lower pontoons can be assembled onto the central branched structure at sea on a floating barge.

Still alternatively, the lower pontoons can be assembled onto the central branched structure afloat at sea.

### BRIEF DESCRIPTION OF THE DRAWINGS

FIG. 1 is a perspective view of a float according to a first embodiment of the invention.

FIG. 2 is a perspective view of a float according to a second embodiment of the invention.

FIG. 3 is a perspective view of a float according to a third embodiment of the invention.

FIG. 4 is a perspective view of a float according to a fourth embodiment of the invention.

FIG. 5 is a perspective view of a float according to a fifth embodiment of the invention.

FIG. 6 represents in perspective a float according to a sixth embodiment of the invention.

FIG. 7 represents in perspective a float according to a seventh embodiment of the invention.

FIG. 8 represents in perspective a float according to an eighth embodiment of the invention.

FIG. 9 shows the presence of inner stiffeners equipping an external column and a lower pontoon of a float according to the invention.

FIG. 10 shows the presence of outer stiffeners equipping the lower pontoons of a float according to the invention.

FIG. 11, FIG. 12 and FIG. 13 show different variants of a method for constructing a float according to the invention.

### DESCRIPTION OF THE EMBODIMENTS

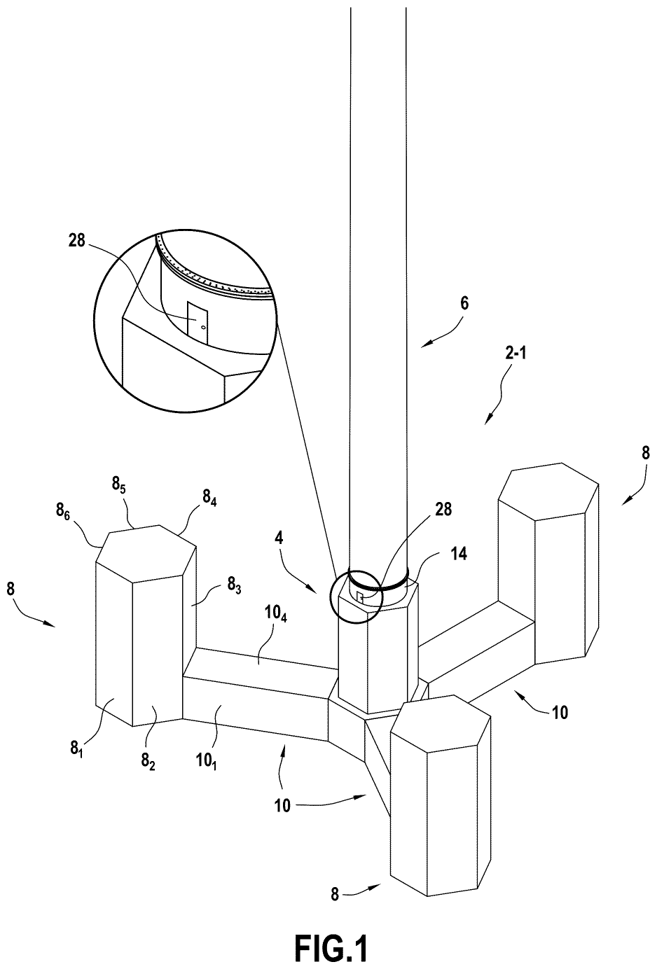

FIG. 1 represents in perspective a semi-submersible float 2-1 for an offshore wind turbine according to a first embodiment of the invention.

The float 2-1 comprises four columns including: a central column 4 intended to receive a wind turbine mast 6; and three external columns 8 which are connected to the central column 4 by branches forming lower pontoons 10.

More specifically, the lower pontoons 10 and the external columns 8 are angularly spaced from each other by 120° to form a star-shaped structure.

The float 2-1 according to the invention has the characteristic of being devoid of upper branches connecting the central column 4 to the external columns 8. In addition, at least the external columns 8 and the lower pontoons 10 are each formed by an assembly of planar panels and each have a polyhedral cross-section.

Thus, in the first embodiment illustrated in FIG. 1, each external column 8 is constituted by the assembly of six planar panels 81 to 86 forming a right prism with a hexagonal base, and each lower pontoon 10 is constituted by the assembly of four planar panels 101 to 104 forming a rectangular parallelepiped (only the planar panels 101 and 104 are visible in FIG. 1).

Of course, the polyhedron constituted by the assembly of the planar panels of the external columns and the lower pontoons could be different: rectangular parallelepiped, right prism with a pentagonal base, etc.

In addition, according to one advantageous arrangement of the invention, the central column 4 is also formed by an assembly of planar panels and thus has a polyhedral cross-section.

Furthermore, still in this first embodiment, the lower pontoons 10 of the float are each connected to an external column 8 at the same face thereof (namely at the level of the planar panel 83 in FIG. 1). Similarly, the lower pontoons 10 are also connected at the same face of the central column 4.

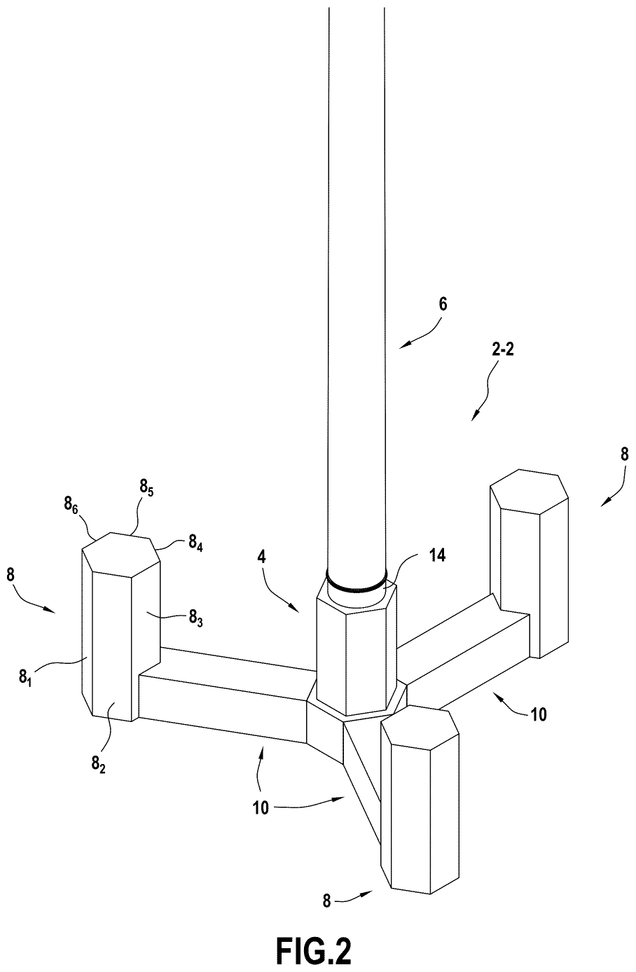

FIG. 2 represents in perspective a semi-submersible float 2-2 for an offshore wind turbine according to a second embodiment of the invention.

This float 2-2 differs from that of the first embodiment in that the lower pontoons 10 of the float are each connected to an external column 8 at two adjacent faces thereof (namely at the level of the planar panel 83 in FIG. 1).

On the contrary, as for the first embodiment, the lower pontoons 10 are also connected at the same face of the central column 4.

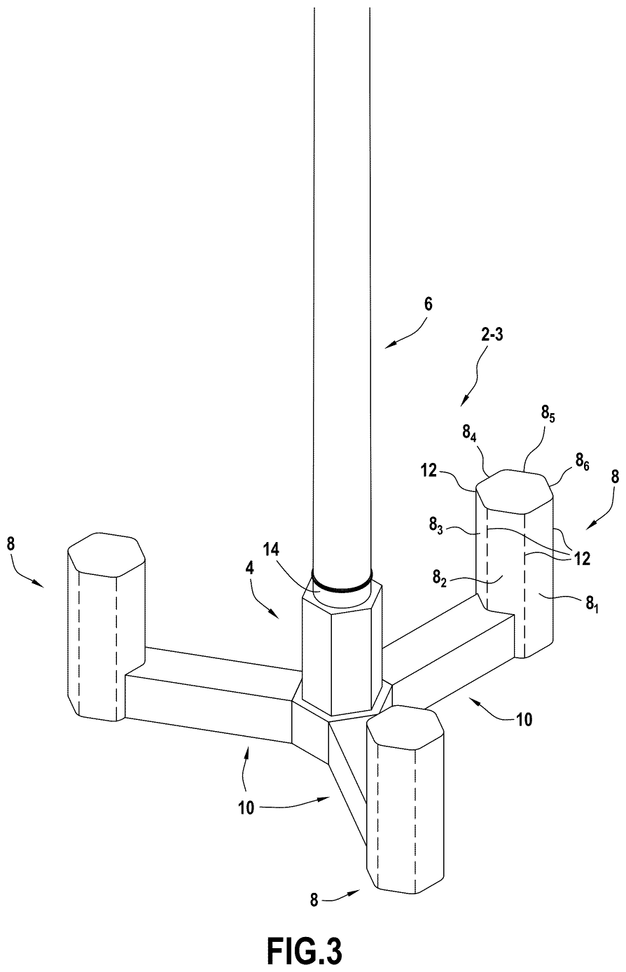

FIG. 3 represents in perspective a semi-submersible float 2-3 for an offshore wind turbine according to a third embodiment of the invention.

This float 2-3 differs from that of the second embodiment in that the planar panels 81 to 86 forming the external columns 8 are assembled together by rounded rods 12 so as to improve their hydrodynamic behavior and reduce stress concentrations.

In addition, it will be noted that in each of the embodiments of FIGS. 1 to 3, the central column 4 ends (at its upper end) with a transition piece 14 with the wind turbine mast 6 which has a cylindrical shape.

Other shapes can be envisaged.

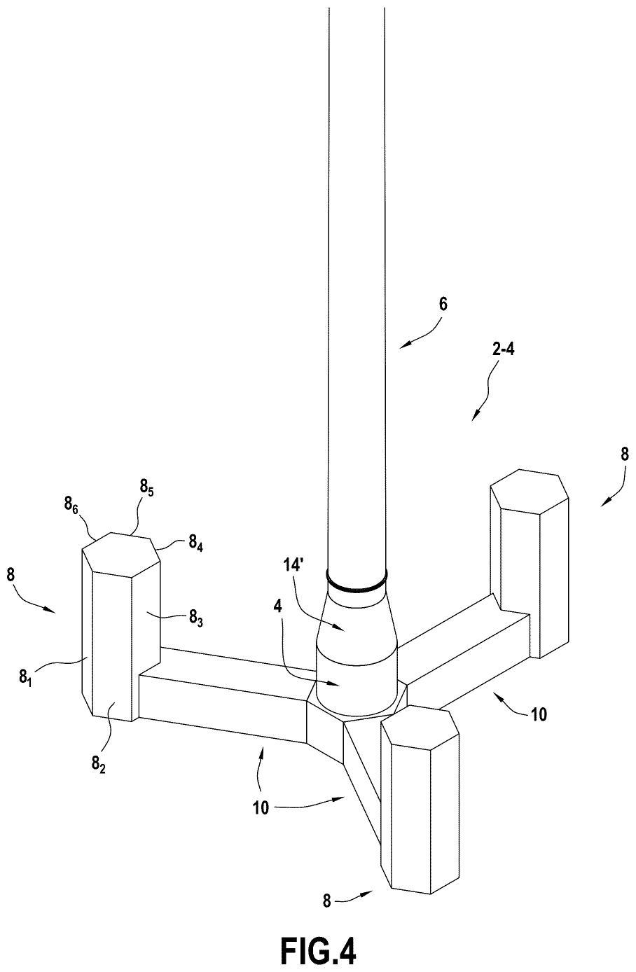

Thus, in the fourth embodiment represented in FIG. 4, the semi-submersible float 2-4 differs from that of the second embodiment in that the transition piece 14′ between the central column 4 and the wind turbine mast 6 has a downwardly-tapered truncated cone shape so as to limit the height of the transition area between the central column and the wind turbine mast.

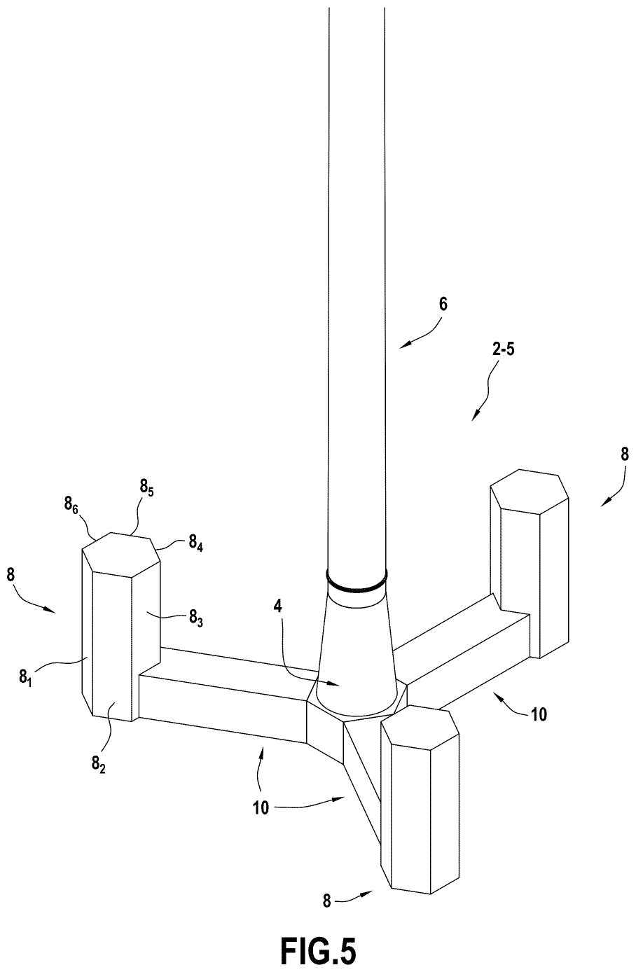

In the fifth embodiment represented in FIG. 5, the central column 4 of the semi-submersible float 2-5 has a downwardly-tapered truncated cone shape.

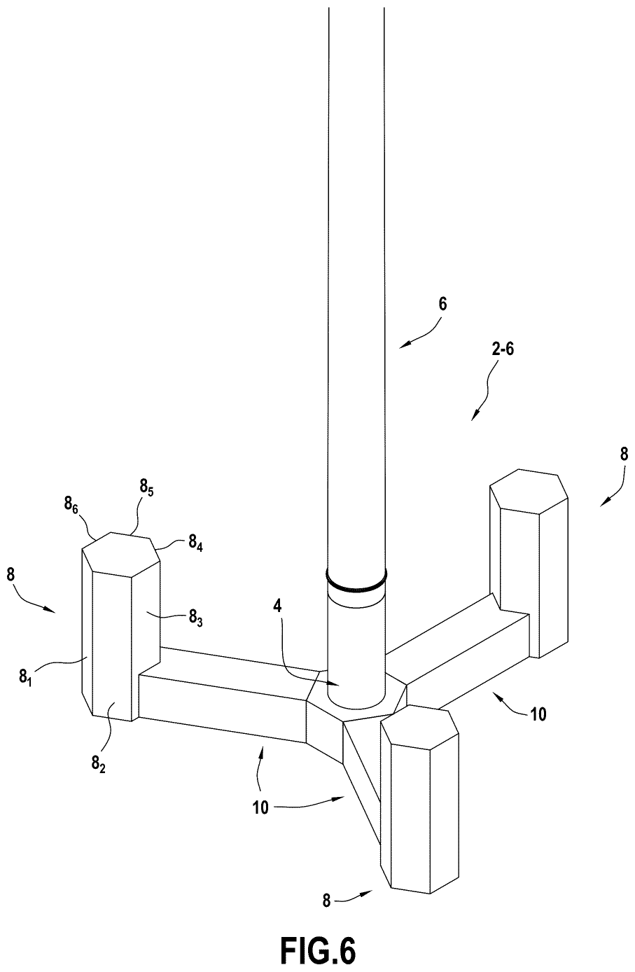

In the sixth embodiment represented in FIG. 6, the central column 4 of the semi-submersible float 2-6 has a cylinder shape.

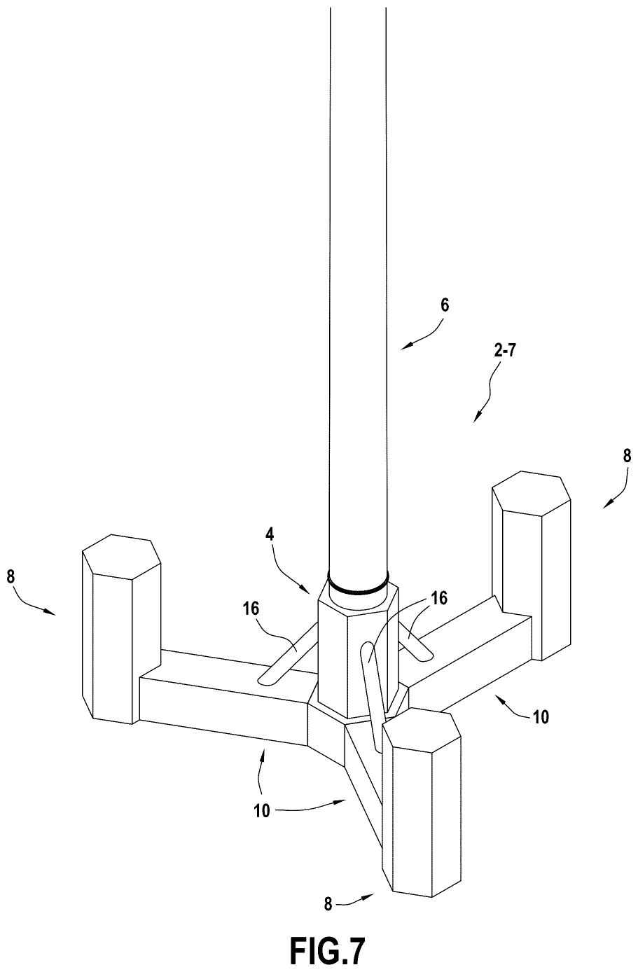

FIG. 7 represents in perspective a semi-submersible float 2-7 for an offshore wind turbine according to a seventh embodiment of the invention.

The float 2-7 differs from that of the second embodiment in that it further comprises members 16, each extending between the central column 4 and one of the lower pontoons 10 in order to partly transfer the in-plane loads from the central column to the lower pontoons.

Thus, the presence of these members 16 allows reducing the height of the lower pontoons 10. In addition, the draft of the float in operation can be reduced, which allows reducing the reinforcements for the resistance to immersion pressure.

As represented in FIG. 7, these members 16 may have a tubular shape. Alternatively, they could have a polyhedral shape.

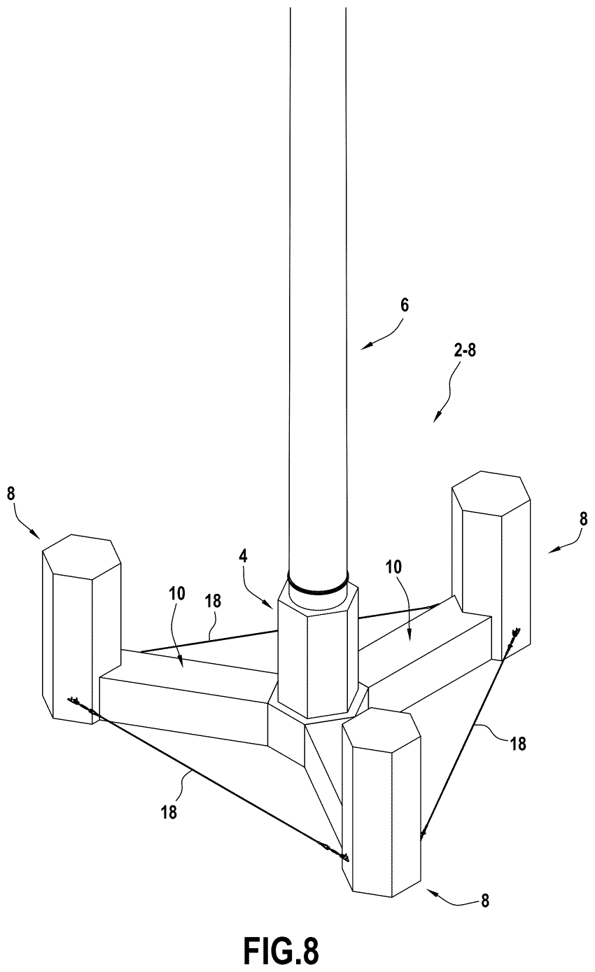

FIG. 8 represents in perspective a semi-submersible float 2-8 for an offshore wind turbine according to an eighth embodiment of the invention.

The float 2-8 differs from that of the second embodiment in that the external columns 8 are connected to each other by prestressed cables 18. More specifically, these prestressed cables 18 are fixed to planar panels of the external columns. The presence of these cables allows reducing the width of the lower pontoons 10 thanks to the out-of-plane moment loads transferred to the cables.

This results in a reduced weight of the float. Wave sensitivity and therefore the loads can also be reduced, which allows reducing the structural reinforcements. In addition, the mounting time of the float is reduced because the dimension of the connection of the lower pontoons is reduced.

The prestress load of the cables 18 is defined so that these remain in tension throughout the lifetime of the float.

Of course, it is possible to envisage that the float has both members as illustrated in FIG. 7 and prestressed cables as illustrated in FIG. 8.

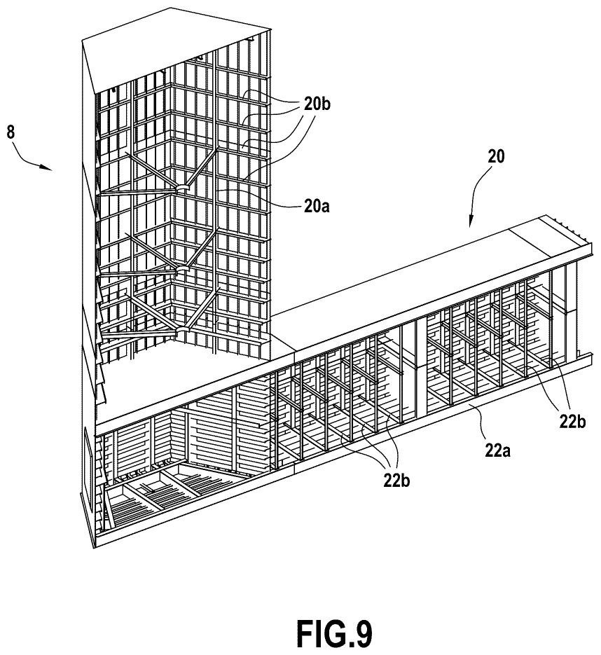

According to one advantageous arrangement represented in particular in FIG. 9, the external columns 8 of the float according to the invention can be reinforced by longitudinal inner stiffeners 20a and/or transverse inner stiffeners 20b.

Similarly, the lower pontoons 10 of the float can be reinforced by longitudinal inner stiffeners 22a and/or transverse inner stiffeners 22b.

Alternatively or additionally, the external columns 8 of the float according to the invention can be reinforced by longitudinal outer stiffeners and/or transverse outer stiffeners.

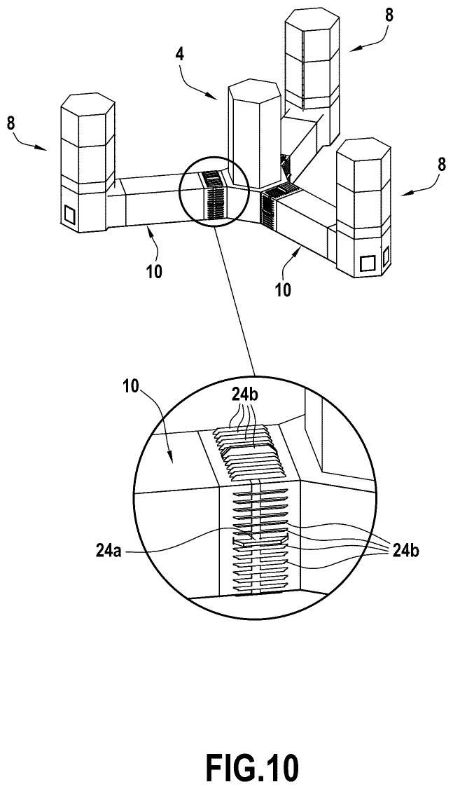

Similarly, as represented in FIG. 10, the lower pontoons 10 of the float can be reinforced by longitudinal outer stiffeners 24a and/or transverse outer stiffeners 24b.

Preferably, as represented in FIGS. 1 to 8, the external columns 8 of the float have the same height and the central column 4 has a different height from that of the external columns.

Advantageously, as represented in FIG. 1, the central column 4 of the float according to the invention comprises an access door 28 to a tower supporting the turbine of the wind turbine which is located below the interface with the tower and internal extra reinforcements of the interface with the tower. This new position of the door results in the lowering of the external platform and a shortening of the access ladder for maintenance personnel from the support vessels.

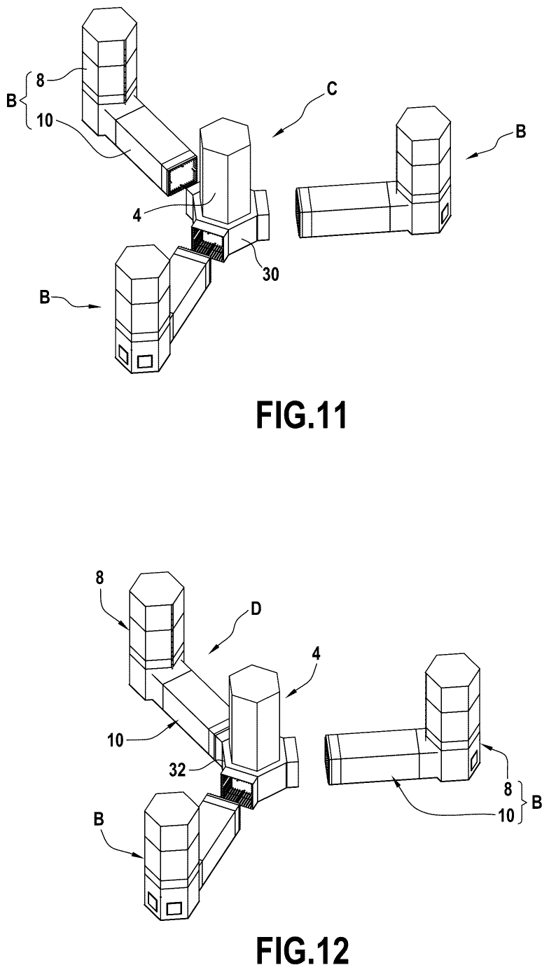

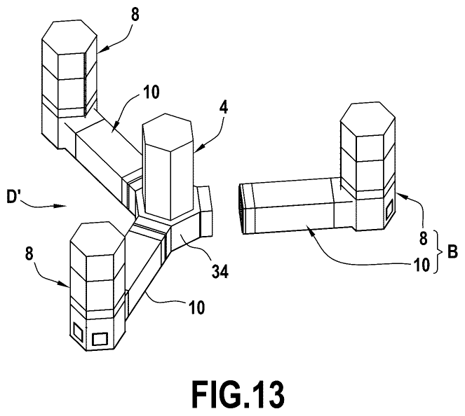

In relation to FIGS. 11 to 13, a method for the modular construction of a float according to the invention will now be described.

Generally, this method comprises the assembly of planar panels together to form, on the one hand, the lower pontoons and, on the other hand, the external columns. The lower pontoons thus formed are then assembled to a central branched structure supporting the central column. Similarly, the external columns thus formed are assembled to the lower branches. Finally, the central column can be assembled to the central branched structure.

Different variants can be stated.

Thus, in the variant represented in FIG. 11, four blocks are assembled together, namely: three identical outer blocks B, each constituted by the assembly of an external column 8 on a lower pontoon 10, and a central block C formed by the assembly of the central column 4 on a central branched structure 30 supporting the central column.

The three outer blocks B are then assembled on the central block C by welding. This variant avoids making welds in sensitive areas in terms of fatigue.

In order to limit the fatigue stresses associated with the welds, the central branched structure 30 is dimensioned so as to space the weld areas of the central column.

In the variant represented in FIG. 12, three blocks are assembled together, namely: two identical outer blocks B which are each constituted by the assembly of an external column 8 on a lower pontoon 10, and a main block D which is formed by the assembly of the central column 4 on a central branched structure 32 comprising a lower pontoon and an external column.

The two outer blocks B are then assembled on the main block D by welding. Compared to the previous one, this variant allows limiting the number of connections and therefore reducing the duration of the final assembly phase. It also avoids making welds in sensitive areas in terms of fatigue.

In the variant represented in FIG. 13, only two blocks are assembled together, namely: an outer block B which is constituted by the assembly of an external column 8 on a lower pontoon 10, and a main block D′ which is formed by the assembly of the central column 4 on a central branched structure 34 comprising two lower pontoons on each of which an external column is assembled.

The outer block B is assembled on the main block D′ by welding. Compared to the previous one, this variant allows further limiting the number of connections. It also avoids making welds in sensitive areas in terms of fatigue.

It should be noted that the welds for assembling the lower pontoons of the outer blocks on these different central branched structures can be external with the use of outer stiffeners.

It should also be noted that as an alternative to welds, the lower pontoons of the outer blocks can be assembled on these different central branched structures using mechanical connectors.

Similarly, these assemblies can be carried out at sea on a floating barge or afloat at sea.

1.-18. (canceled)

19. A semi-submersible float, in particular for an offshore wind turbine, comprising four columns including a central column intended to receive a wind turbine mast, and at least three external columns that are connected to the central column by branches forming lower pontoons, the float being devoid of upper branches connecting the central column to the external columns and the external columns and the lower pontoons each being formed by an assembly of planar panels and each having a polyhedral cross-section,
wherein the planar panels forming the external columns are assembled together by at least one rounded rod so as to improve their hydrodynamic behavior and reduce stress concentrations.

20. The float according to claim 19, wherein the central column has a downwardly-tapered truncated cone shape.

21. The float according to claim 19, wherein the central column ends with a transition piece having a downwardly-tapered truncated cone shape.

22. The float according to claim 19, wherein the central column has a downwardly-tapered truncated cone shape.

23. The float according to claim 19, wherein the external columns have the same height and the central column has a height different from that of the external columns.

24. The float according to claim 19, wherein the central column comprises an access door to a tower supporting the turbine of the wind turbine located below the interface with the tower and internal extra reinforcements of the interface with the tower.

25. The float according to claim 19, wherein the planar panels forming the external columns and the lower pontoons are reinforced by longitudinal inner stiffeners and/or transverse inner stiffeners.

26. The float according to claim 19, wherein the planar panels forming the external columns and the lower pontoons are reinforced by longitudinal outer stiffeners and/or transverse outer stiffeners.

27. The float according to claim 19, wherein the external columns are connected to each other by prestressed cables.

28. The float according to claim 19, wherein it further comprises members, each extending between the central column and one of the lower pontoons in order to partly transfer the in-plane loads from the central column to the lower pontoons.

29. The float according to claim 28, wherein the members have a tubular or polyhedral shape.

30. The float according to claim 19, wherein the lower pontoons are angularly spaced from each other by 120° to form a star-shaped structure.

31. A method for the modular construction of a float according to claim 19, wherein it comprises:
the assembly of planar panels together to form, on the one hand, the lower pontoons and, on the other hand, the external columns,
the assembly of the lower pontoons to a central branched structure supporting the central column,
the assembly of the external columns on the lower pontoons, and
the assembly of the central column on the central branched structure.

32. The method according to claim 31, wherein the lower pontoons are assembled onto the central branched structure by welding.

33. The method according to claim 32, wherein the welds for assembling the lower pontoons onto the central branched structure are external, using outer stiffeners connected by welding.

34. The method according to claim 31, wherein the lower pontoons are assembled onto the central branched structure by means of mechanical connectors.

35. The method according to claim 31, wherein the lower pontoons are assembled onto the central branched structure at sea on a floating barge.

36. The method according to claim 31, wherein the lower pontoons are assembled onto the central branched structure afloat at sea.
